(19) United States
(12) Patent Application Publication
(10) Pub. No.: US 2009/0011134 A1
(43) Pub. Date: Jan. 8, 2009

(54) Zirconium Stabilised Fischer Tropsch Catalyst and Catalyst Support

(76) Inventors: Arend Hoek, Amsterdam (NL); Gerardus Petrus Niesen, Amsterdam (NL)

Correspondence Address: SHELL OIL COMPANY, P O BOX 2463, HOUSTON, TX, 772522463, US

(21) Appl. No.: 12/158,204

(22) PCT Filed: Dec. 20, 2006
(86) PCT No.: PCT/EP2006/069956

§ 371 Date: Jun. 19, 2008

(30) Foreign Application Priority Data
Dec. 22, 2005 (EP) 05112832.0

(51) Int. Cl. B05D 3/02; B01J 32/00; B01J 23/34

(52) U.S. Cl. 427/372.2; 502/439; 502/324

(57) ABSTRACT

The present invention relates to a method of preparing a catalyst support or a supported metal catalyst, the method comprising: (a) admixing a porous refractory oxide with a water soluble zirconium precursor in an alkaline solution, and if a supported metal catalyst is prepared, with a precursor of the metal, yielding a slurry, (b) drying the slurry, and (c) calcining; thus yielding a catalyst support or supported metal catalyst having an increased hydrothermal strength. The invention further relates to a method of preparing a catalyst body, the method comprising: (a) admixing a porous refractory oxide with a water soluble zirconium precursor in an alkaline solution, and if a supported metal catalyst is prepared, with a precursor of the metal or the metal itself, yielding a slurry, (b) coating metal with the slurry, (c) drying the coating, and (d) calcining; thus yielding a catalyst body comprising a catalyst support or supported metal catalyst having an increased hydrothermal strength In a preferred embodiment, the zirconium containing compound comprises zirconium carbonate in an ammonium solution. The improved hydrothermal strength is particularly suitable for slurry-type Fischer-Tropsch reactors.

The present invention relates to a catalyst support and a supported metal catalyst. The invention also relates to a process for the preparation of the catalyst support and the supported metal catalyst. Further, the invention relates to a Fischer-Tropsch process for the preparation of hydrocarbons from synthesis gas in which process a supported metal catalyst according to this invention is used.

The Fischer-Tropsch process can be used for the conversion of hydrocarbonaceous feed stocks into liquid and/or solid hydrocarbons. The feed stock (e.g. natural gas, associated gas and/or coal-bed methane, residual (crude) oil fractions or coal) is converted in a gasifier, optionally in combination with a reforming unit, into a mixture of hydrogen and carbon monoxide (this mixture is often referred to as synthesis gas or syngas).

The synthesis gas is then fed into a Fischer-Tropsch reactor where it is converted in a single step over a suitable catalyst at elevated temperature and pressure into paraffinic compounds ranging from methane to high molecular weight modules comprising up to 200 carbon atoms, or, under particular circumstances, even more.

The hydrocarbons formed in the Fischer-Tropsch reactor proceed to a hydrogenation unit, optionally a hydroisomerisation/hydrocracking unit, and thereafter to a distillation unit.

Products of the Fischer-Tropsch synthesis may range from methane to heavy paraffinic waxes. Preferably, the production of methane is minimised and a substantial portion of the hydrocarbons produced have a carbon chain length of a least 5 carbon atoms. Preferably, the amount of C₅+ hydrocarbons is at least 60% by weight of the total product, more preferably, at least 70% by weight, even more preferably, at least 80% by weight, most preferably at least 85% by weight. Reaction products which are liquid phase under reaction conditions may be separated and removed, optionally using suitable means, such as one or more filters. Internal or external filters, or a combination of both, may be employed. Gas phase products such as light hydrocarbons and water may be removed using suitable means known to the person skilled in the art.

In the Fischer-Tropsch synthesis, as in many other chemical reactions, the solid, supported catalyst, the reactants and a diluent, if present, in contact with one another usually form a three phase system of gas, liquid and solid. Such three phase systems may be operated, for example, in a packed-bed reactor or in a slurry-bubble reactor. A packed-bed reactor may comprise a packed bed of solid catalyst particles through which there is a flow of gaseous and liquid reactants. A slurry-bubble reactor may comprise a continuous phase of liquid with the solid catalyst suspended therein and gaseous reactants flowing as bubbles through the liquid. Alternatively, a structured, fixed catalyst system with high voltage can be used within a slurry-type of operation, hereafter called immobilised slurry. In all such operations it is important that the supported catalyst is mechanically strong, so that the catalyst particles maintain their integrity through the entire operation. The stronger the catalyst support or the supported catalyst, the higher a catalyst bed may be in a packed-bed reactor or the longer the residence time of the catalyst may be in a slurrybubble reactor.

Numerous types of reactor systems have been developed for carrying out the Fischer-Tropsch reaction. For example, Fischer-Tropsch reactor systems include fixed bed reactors, especially multi-tubular fixed bed reactors, fluidised bed reactors, such as entrained fluidised bed reactors and fixed fluidised bed reactors, and slurry bed reactors such as three-phase slurry bubble columns and ebulated bed reactors.

In a Fischer-Tropsch process, water in the form of steam may be generated. Thus a Fischer-Tropsch catalyst preferably has a reasonable resistance to degradation by water, that is, it should have a reasonable hydrothermal strength. The hydrothermal strength is particularly important for catalysts used in a Fischer-Tropsch slurry process.

According to one aspect of the present invention, there is provided a method of preparing a catalyst support or a supported metal catalyst, the method comprising:

(a) admixing a porous refractory oxide with a zirconium precursor, and if a supported metal catalyst is prepared, with a precursor of the metal or the metal itself, yielding a slurry,

(b) drying the slurry, and

(c) calcining;

thus yielding a catalyst support or supported metal catalyst having an increased hydrothermal strength.

The invention also provides a catalyst support or supported metal catalyst comprising a porous refractory oxide and zirconium, the catalyst support or supported metal catalyst having an increased hydrothermal strength.

The invention further provides a method of preparing a catalyst body, the method comprising:

(a) admixing a porous refractory oxide with a water soluble zirconium precursor in an alkaline solution, and if a supported metal catalyst is prepared, with a precursor of the metal or the metal itself, yielding a slurry,

(b) coating metal with the slurry,

(c) drying the coating, and

(d) calcining;

thus yielding a catalyst body comprising a catalyst support or supported metal catalyst having an increased hydrothermal strength.

The invention further provides a catalyst body comprising a catalyst support or supported metal catalyst having an increased hydrothermal strength. The metal on which the catalyst support or supported metal catalyst is coated preferably is iron or steel, more preferably steel. The metal can have a form or shape selected from the group consisting of wire, gauze, honeycomb, monolith, sponge, mesh, webbing, foil construct and woven mat form, or any combination of these. Preferably it is in the form of a wire.

The metal on which the catalyst support or supported metal catalyst is coated may be further shaped so that the outer structure obtains a regular or irregular shape, or a mixture thereof. Such include cylinders, cubes, spheres, avoids, etc, and other shaped polygons.

The catalyst support or supported metal catalyst is preferably coated on the metal, for example a metal wire, by means of dip coating.

The metal coated with a catalyst support or supported metal catalyst preferably is a catalyst body suitable for use in Fischer-Tropsch slurry reactors. Most preferably the catalyst body is used in immobilized slurry.

The ingredients that can be used and those that are preferably used in step a) of the method of preparing a catalyst support or a supported metal catalyst are the same as the ingredients used in step a) of the method of preparing a catalyst body.

The hydrothermal strength is the resistance of a catalyst to water attack or the strength of a catalyst in the presence of water.

Thus hydrothermal strength as used herein refers to the mechanical strength of a catalyst support (or supported metal catalyst) after if has undergone the hydrothermal test, as described herein. The term ‘increased hydrothermal strength’ as used herein refers to the hydrothermal strength of a catalyst support (or supported metal catalyst) comprising zirconium, being greater than an equivalent catalyst support (or supported metal catalyst) not comprising zirconium.

One indication of the mechanical strength of a catalyst (hydrothermal strength if measured after it has undergone the hydrothermal test) is its resistance to attrition. The resistance to attrition of slurry material can be determined as described in the examples. The resistance of attrition of a catalyst body can be determined as follows. The catalyst body comprising a catalyst support (or supported metal catalyst) can be rotated within a (simple) drum with one internal baffle plate, over a standard number of drum rotations. The loss of material can then be determined as the change in weight of material below 0.84 mm, judged as being “fines”.

In a process in accordance with the present invention a porous refractory oxide is admixed with a zirconium precursor, and optionally with a precursor of a catalytically active metal or the metal itself, yielding a slurry. During calcination the zirconium precursor is typically converted to zirconium oxide (ZrO₂) also known as zirconia. The zirconium precursor may comprise zirconia, preferably the zirconium precursor comprises less than 10 w % zirconia, more preferably less than 5 w % zirconia, most preferably it is zirconia free.

It has been found that the presence of zirconia in a catalyst in accordance with the present invention can increase the hydrothermal strength of the supported metal catalyst or catalyst support.

Typically the catalyst is used for a Fischer-Tropsch process.

Preferably the zirconium precursor is water soluble.

Preferably the zirconium precursor used in step (a) comprises an ammonium zirconium compound.

The zirconium precursor may be an alkyl ammonium compound for example, a mono-, di-, tri- or tetra-alkyl ammonium compound, or may be an unsubstituted ammonium zirconium compound. One example is tetra-ethyl ammonium zirconium.

Preferably the zirconium precursor is in an alkaline solution, such as an ammonium solution.

Preferably the zirconium precursor comprises zirconium ammonium carbonate (for example of the formula Zr(CO₃)₂ in an ammonium solution). One supplier of zirconium ammonium carbonate is Mel Chemicals of Great Britain under the Trade Mark ‘Bacote 20’.

The zirconium precursor may comprise anionic hydroxylated zirconium polymers.

Preferably the zirconium precursor does not contain formaldehyde.

When an ammonium zirconium carbonate is used as zirconium precursor in step (a) this is typically converted during calcination to zirconium oxide (ZrO₂) also known as zirconia.

The zirconium present in the catalyst in accordance with the second aspect of the present invention is preferably in the form of zirconia.

Preferably the catalyst comprises between 0.1-25% w (total dry base) zirconia, more preferably 1-10% w zirconia.

Preferably the metal of the supported metal catalyst comprises a Group VIII metal component, such as cobalt, iron, nickel and/or ruthenium; preferably cobalt and/or iron, more preferably cobalt.

The optimum amount of catalytically active metal present on the carrier depends, inter alia, on the specific catalytically active metal. Typically, the amount of the active metal (such as cobalt) present in the catalyst may range from 1 to 100 parts by weight per 100 parts by weight of carrier material, preferably from 10 to 50 parts by weight per 100 parts by weight of carrier material.

A further advantage of including zirconium precursors such as zirconium ammonium carbonate is that the calcination temperature can be increased without the catalyst and the support reacting together. This produces a mechanically stronger catalyst.

For example, with a cobalt on titania catalyst, cobalt titanate will form at higher calcination temperatures, the formation of cobalt titanate reduces the catalyst activity and so is not wanted. Thus the calcination temperature is generally limited to a temperature at which cobalt titanate will not be formed.

Preferably the calcination temperature is approximately 650° C. or less.

Including a zirconium precursor in the supported metal catalyst allows the calcination temperature to be increased by a certain extent (relative to a catalyst without zirconium) without the formation of cobalt titanate.

The catalytically active metal may be present in the catalyst together with one or more metal promoters or cocatalysts. The promoters may be present as metals or as the metal oxide, depending upon the particular promoter concerned. Suitable promoters include oxides of metals from Groups IIA, IIIB, IVB, VB, VIIB and/or VIIB of the Periodic Table, oxides of the lanthanides and/or the actinides. Preferably, the catalyst comprises at least one of an element in Group IVB, VB and/or VIIB of the Periodic Table, in particular titanium, manganese and/or vanadium. As an alternative or in addition to the metal oxide promoter, the catalyst may comprise a metal promoter selected from Groups VIIB and/or VIII of the Periodic Table. Preferred metal promoters include rhenium, platinum, palladium and manganese.

The promoter, if present in the catalyst, is typically present in an amount of from 0.1 to 60 parts by weight per 100 parts by weight of carrier material. It will however be appreciated that the optimum amount of promoter may vary for the respective elements which act as promoter.

A most suitable catalyst comprises cobalt as the catalytically active metal and manganese and/or vanadium as a promoter.

The refractory oxide is a material having a large surface area. The surface area is typically at least 0.5 m²/g, suitably at least 10 m²/g, especially at least 25 m²/g, and more specially at least 35 m²/g, based on BET surface area measurements according to ASTM D3663-92. Suitably the surface area is at most 400 m²/g, especially at most 200 m²/g, preferably at most 100 m²/g on the same basis. More preferably the surface area is in the range of from 30 m²/g to 70 m²/g, on the same basis.

The porous refractory oxide can be alumina, silica, titania, zirconia or mixtures thereof. Preferably the porous refractory oxide is titania.

In one embodiment, the slurry comprises a dispersant. A suitable dispersant is, for example, a titanate compound, preferably an organic titanate salt, more preferably a salt of lactic acid titanate chelate, most preferably an ammonium salt of lactic acid titanate chelate. An ammonium salt of lactic acid titanate chelate may be obtained from DuPont (Tyzor®).

Preferably step (b) of the method of preparing a catalyst support or a supported metal catalyst includes the technique of spray-drying, although extrusion or milling may also be used to prepare the catalyst.

Spray-drying is preferably carried out with an air temperature of around 250° C. whilst the product remains at approximately 70-80° C.

An alternative to spray drying may be gradual evaporation of water, for example, by using a dryer. The dryer can be a rotary dryer, a drum dryer or a spray dryer.

Preferably the average particle diameter (APD) for spray dried supports is between 4-8 μm. Preferably the particles deagglomerate to less than 1 μm.

The catalyst support or a supported metal catalyst according to present invention is particularly suitable for catalysts which are used in a three phase slurry-type Fischer-Tropsch reactor.

According to a further aspect of the present invention there is provided the use of a catalyst support or supported metal catalyst as described herein, in a Fischer-Tropsch Process.

The catalyst body according to the invention is particularly suitable for catalysts which are used in a immobilised slurry-type Fischer-Tropsch process.

The Fischer-Tropsch synthesis is preferably carried out at a temperature in the range from 125 to 350° C., more preferably 175 to 275° C., most preferably 200 to 260° C. The pressure preferably ranges from 5 to 150 bar abs., more preferably from 5 to 80 bar abs.

Hydrogen and carbon monoxide (synthesis gas) is typically fed to the three-phase slurry reactor at a molar ratio in the range from 0.4 to 2.5.

Preferably, the hydrogen to carbon monoxide molar ratio is in the range from 1.0 to 2.5.

The gaseous hourly space velocity may very within wide ranges and is typically in the range from 1500 to 10000 Nl/l/h, preferably in the range from 2500 to 7500 Nl/l/h.

Preferably, the superficial gas velocity of the synthesis gas is in the range from 0.5 to 50 cm/sec, more preferably in the range from 5 to 35 cm/sec.

Typically, the superficial liquid velocity is kept in the range from 0.001 to 4.00 cm/sec, including liquid production. It will be appreciated that he preferred range may depend on the preferred mode of operation.

The Fischer-Tropsch synthesis can be carried out in a slurry phase regime or an ebullating bed regime, wherein the catalyst particles are kept in suspension by an upward superficial gas and/or liquid velocity.

Another regime for carrying out the Fischer-Tropsch reaction is a fixed bed regime, especially a trickle flow regime. A very suitable reactor is a multitubular fixed bed reactor.

Embodiments of the present invention will now be described, by way of example only.

### EXAMPLES

Various samples (catalyst precursors) were prepared; some according to the invention, others as comparative examples.

### Ingredients

Some samples were prepared using, among other ingredients, Bindzil® (silica sol ex Eka Chemicals) or Bacote® 20 (ammonium zirconium carbonate ex MEL Chemicals). Some properties of these ingredients are set out in the tables below.

TABLE 1
Bindzil ® Properties

| Property | Value | |
|---|---|---|
| SiO₂ content | 30 | wt % |
| Surface area | 220 | m₂/g |
| Particle size | 15 | nm |
| Na₂O | <0.1 | wt % |
| pH | 9.0 | |
| Density | 1.2 | g/cm³ |
| Viscosity | <10 | cPs |

TABLE 2
Bacote ® 20 properties.

| Property | Value |
|---|---|
| Ammonium zirconium carbonate | 20 wt % |
| | (calculated as ZrO₂) |
| Viscosity | 5 centipoise |
| pH | 9-9.5 |
| Specific Gravity | 1.36 |
| Solution Stability at 70° C. | >24 hours |

### Hydrothermal Strength Determination

The following tests were used to determine the hydrothermal strength of the prepared samples.

The strength of the catalyst precursors was first determined using the shear test described below.

Samples of the catalysts were then exposed to hydrothermal and hydrodynamic conditions in an aqueous environment, to simulate the effects of temperature and pressure on a slurry phase catalyst.

After the exposure to the hydrothermal test, a subsequent shear test was carried out. The hydrothermal strength of the catalyst can be determined by comparing the shear test results without the hydrothermal treatment and the shear test results following hydrothermal treatment. Typically a drop in shear strength occurs after hydrothermal treatment—this is preferably as low as possible.

### Shear Test

The Shear Test is carried out as follows: an Ultra Turrax T50/S50N/G45F blending machine supplied by IKA operates a stirrer at a speed of 5750 rpm. The stirrer has a G45F dispersing element, which has a rotor with an outer diameter of 40 mm, and a stator having an outer diameter of 45 mm and a inner diameter of 41 mm. Each of the rotor and stator have a series of vertical slits, whose width and height are 2 mm and 12 mm. The stirrer is located 18 mm from the base of a 250 ml beaker having a height of 120 mm and an inner diameter of 55 mm. In the beaker is 100 ml aqueous sample comprising a catalyst concentrate of 5% v/v in 100 g of water. The beaker is secured in a thermostatic bath keeping the temperature at 20° C.±2° C. In testing, the stirrer is operated for 30 minutes.

The shear test can be performed on particles of less than about 500 μm. In case of larger particles to be tested, such particles can be crushed or otherwise reduced in size to a size of 500 μm or less.

Particle size distribution (PSD) measurements are carried out by means of Laser Light Diffraction (LLD).

The apparatus is a Malvern Mastersizer Micro+. After completion of a sheer test, a representative sample is taken and its PSD measured. The two parameters that are used to define resistance against attrition are Average Particle Diameter (APD) and fr<10. APD is measured as the volume weighted average particle diameter, D(4,3), or the De Broucker mean. Fr<10 is the volume fraction of particles having a diameter of <10 μm.

The attrition rate as used herein is defined as the percent decrease in APD during a test. In addition the attrition rate is further defined as the absolute increase in the amount of particles having a diameter of less than 10 μm, the ‘fr<10’. The latter parameter gives additional and important information on the amount of so-called “fines” that may be formed during a test. Fines are detrimental to process operations in slurry as they may clog the filters which are used for catalyst/product separation in slurry operation.

The APD is defined as:

$$Δ ( APD ) = {\underline{APD}}_{t = 0} - {\underline{APD}}_{t = 30} * 100 ( \% )$$

$${\underline{APD}}_{t = 0}$$

The increase in fr<10 is defined as

Δ(fr<10)=[fr<10]ₜ₌₃₀−[fr<10]ₜ₌₀

In order to determine the repeatability of the test a series of tests was carried out. Repeatability is defined as: a value below which the absolute difference between two test results obtained with the same method on identical test material under the same conditions may be expected to lie with a specified probability. In the absence of other information, the confidence level is 95%. The relative standard deviations, for both parameters, are less than 5%.

The test also needs to be reliable over longer periods of time, i.e. the equipment should not show any signs of wearing down and attrition rate should remain constant. In order to verify that this is the case, a reference catalyst has been tested regularly, i.e. each (series of) test(s) was preceded by a reference test.

All catalysts are tested at 5% v/v concentration, i.e. the volume-based concentration, which is calculated using the following equation:

$$\% v / v = \frac{Mcat}{Mcat [ 1 - PV * PAD ] + [ Ml / dL ] * PAD} * 100$$

Where Mcat is the mass of catalyst, ML is the mass of the liquid, dL is the density of the liquid, PV is the pore volume of the catalyst (in ml/g, measured manually by adding small amounts of water to a known mass of catalyst until wetness occurs,), and PAD is the particle density of the catalyst, calculated from PV and the skeletal density, SKD, of the catalyst:

$$PAD = \frac{1}{( 1 / SKD ) + PV} ( g \text{/} ml )$$

$$SKD = \sum MFi * di ( g \text{/} ml )$$

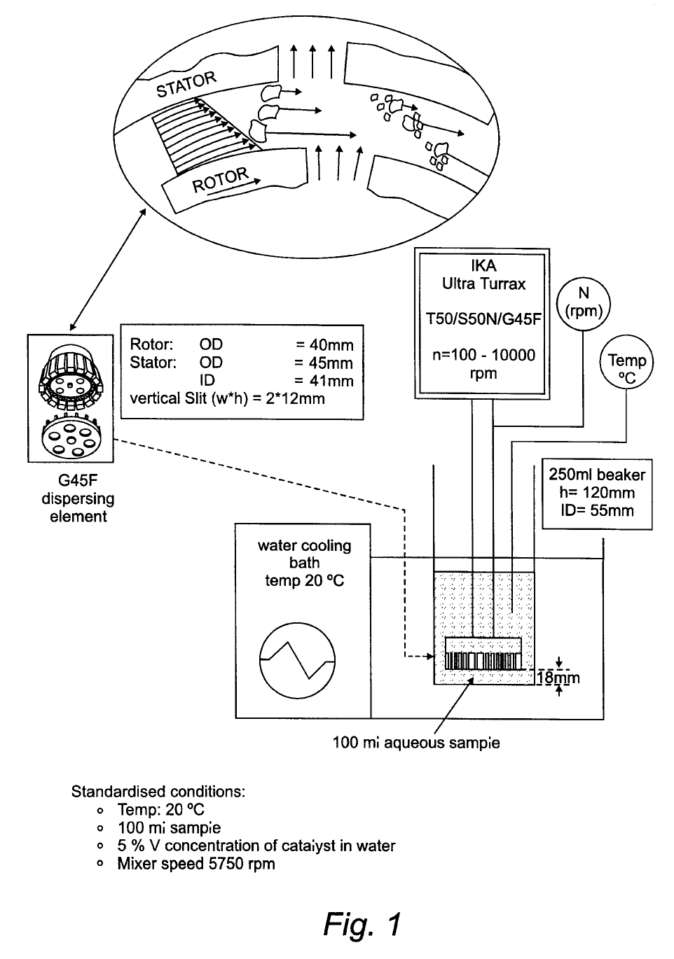

A pictorial representation of this test is shown in the accompanying drawing, FIG. 1.

The above test is reliable, simple, quick and efficient, being conveniently performed in water as the liquid medium at a temperature of 20° C. The test mimics the shear conditions occurring in a commercial process (pump loop, stirrers, other internals) by exposing the catalyst particles to a high shear mixer/disperser for a specified period of time. The change in the particle size distribution of the catalyst is a measure of its strength or attrition resistance. The test can be conducted with an estimated repeatability of better than ±5%.

### Hydrothermal Exposure/Hydrothermal Test

A catalyst sample of 25 g is weighed and put into an autoclave, after which 100 g water is added. The autoclave is sealed and heated to 220° C. for 24 hours. Next the sample is filtered and dried at 120° C.

The shear test is then carried out to determine the mechanical strength of the catalyst after exposure to such aqueous conditions.

### Sample Preparation

Various aqueous mixtures containing all the base ingredients for a cobalt/manganese/titania based catalyst precursor was prepared by mixing and kneading titania (TiO₂), a Co/Mn co-precipitate, a standard dispersant, and water. To some mixtures Bacote® 20 (ammonium zirconium carbonate) was added. To some mixtures Bindzil® (SiO₂) was added. The prepared mixtures were milled and slurries were obtained. Each slurry was shaped by means of spray drying and finally calcined in a muffle furnace. The ammonium zirconium carbonate present in a number of the prepared slurries was converted to zirconia (ZrO₂) during the calcination.

Table 3 below is a table showing the attrition resistance before and after a hydrothermal test for titania-based catalysts including and excluding zirconia. The first catalyst in table 3 is a comparative example without zirconia. After the hydrothermal exposure, a significant decrease in average particle diameter (77.2%) is observed and a high percentage (76.8%) of the unwanted ‘fines’ (i.e. particles smaller than μm) are present.

In contrast, following the hydrothermal exposure, the second catalyst (comprising zirconia) shown in table 3 only exhibits a small reduction in average particle diameter (4%) and has only a small percentage of fines (6.4%).

TABLE 3

| | | Attrition | | Attrition | |
|---|---|---|---|---|---|
| | | resistance before | | resistance after | |
| | | hydrothermal test | | hydrothermal test | |
| | Catalyst | Δ | | Δ | |
| | composition | (APD) | Fr < 10 | (APD) | Fr < 10 |
| | (% w) | (%) | μm (%) | (%) | μm (%) |
| Comparative | TiO₂ = 69 | 8.2 | 7.2 | 77.2 | 76.8 |
| | Co = 19.4 | | | | |
| | Mn = 0.72 | | | | |
| According | TiO₂ = 63.8 | 0.0 | 0.0 | 4.0 | 6.4 |
| to | Co = 18.5 | | | | |
| invention | Mn = 0.83 | | | | |
| | ZrO₂ = 9.5 | | | | |

Table 4 below compares a catalyst comprising Bacote® 20 (i.e. a zirconium containing compound) and one without Bacote® 20 or zirconium. Two samples were prepared of each catalyst, one calcined at 600° C. and the other calcined at 625° C. For both pairs of samples, the reduction in average particle size diameter is less for the catalyst comprising Bacote/zirconium than the one without Bacote/zirconium. Also the amount of fines is less for the catalyst containing Bacote/zirconium than the one without.

TABLE 4

| | | | Attrition | |
|---|---|---|---|---|
| | | | resistance after | |
| | Catalyst | | hydrothermal test | |
| | composition | Calcination | Δ (APD) | Fr < 10 μm |
| | (% w) | (° C.) | (%) | (%) |
| Comparative | TiO₂ = 72.7 | Calcined at | 66.8 | 65.8 |
| | Co = 21.4 | 600 | | |
| | Mn = 1.1 | | | |
| According | TiO₂ = 72.0 | Calcined at | 48.5 | 26.5 |
| to | Co = 21.1 | 600 | | |
| invention | Mn = 1.1 | | | |
| | ZrO₂ = 1.0 | | | |
| Comparative | TiO₂ = 72.7 | Calcined at | 47.3 | 43.9 |
| | Co = 21.4 | 625 | | |
| | Mn = 1.1 | | | |
| According | TiO₂ = 72.0 | Calcined at | 44.7 | 41.3 |
| to | Co = 21.1 | 625 | | |
| invention | Mn = 1.1 | | | |
| | ZrO₂ = 1.0 | | | |

Table 5 is a table showing the catalyst strength for various zirconia-containing catalysts compared to catalysts not containing zirconia. From Table 5 below it is clear that the addition of zirconia (from Bacote®) rather than silica ((SiO₂) from Bindzil®) shows a greater attrition resistance after the hydrothermal exposure.

TABLE 5

| | | | Attrition | |
|---|---|---|---|---|
| | | | resistance after | |
| | Catalyst | | hydrothermal test | |
| | composition | Calcination | Δ (APD) | Fr < 10 μm |
| | (% w) | (° C.) | (%) | (%) |
| Comparative | TiO₂ = 69.0 | Calcined at | 21.6 | 22 |
| | Co = 20.3 | 650 | | |
| | Mn = 1.1 | | | |
| | SiO₂ = 5.0 | | | |
| According | TiO₂ = 69.0 | Calcined at | 0.0 | 0.0 |
| to | Co = 20.3 | 650 | | |
| invention | Mn = 1.1 | | | |
| | ZrO₂ = 5.0 | | | |
| Comparative | TiO₂ = 63.3 | Calcined at | 16.3 | 4.6 |
| | Co = 18.7 | 650 | | |
| | Mn = 1.0 | | | |
| | SiO₂ = 10.0 | | | |
| According | TiO₂ = 60.8 | Calcined at | 0.8 | 1.0 |
| to | Co = 20.2 | 650 | | |
| invention | Mn = 1.1 | | | |
| | ZrO₂ = 10.0 | | | |

Thus it has been found that the inclusion of a zirconium precursor, such as zirconia, in a catalyst in accordance with the present invention can increase the hydrothermal strength of the supported metal catalyst.

Improvements and modifications may be made without departing from the scope of the invention.

1. A method of preparing a catalyst support or a supported metal catalyst, the method comprising:
(a) admixing a porous refractory oxide with a water soluble ammonium compound in an alkaline solution, and if a supported metal catalyst is prepared, with a precursor of the metal or the metal itself, yielding a slurry,
(b) spray-drying the slurry, and
(c) calcining;
wherein the ammonium zirconium compound comprises less than 10 wt % zirconia.

2. A method of preparing a catalyst body, the method comprising:
(a) admixing a porous refractory oxide with a water soluble ammonium zirconium compound in an alkaline solution, and if a supported metal catalyst is prepared, with a precursor of the metal or the metal itself, yielding a slurry,
(b) coating metal with the slurry,
(c) drying the coating, and
(d) calcining;
wherein the ammonium zirconium compound comprises less than 10 wt % zirconia.

3. A method according to claim 2, wherein the metal is iron or steel.

4. A method according to claim 2, wherein the metal has a form or shape selected from the group consisting of wire, gauze, honeycomb, monolith, sponge, mesh, webbing, foil construct and woven mat form, or any combination thereof.

5. A method according to claim 2, wherein the coating is applied by means of dipcoating.

6. A method as claimed in claim 1, wherein the porous refractory oxide is selected from the group consisting of alumina, silica, titania, zirconia and mixtures thereof.

7. A method as claimed in claim 1, wherein the ammonium zirconium compound is in an ammonium solution.

8. A method as claimed in claim 1, wherein the zirconium precursor comprises ammonium zirconium carbonate.

9. A method as claimed in claim 1, wherein the zirconium precursor comprises an alkyl ammonium compound or an unsubstituted ammonium compound.

10. A method as claimed in claim 1, wherein the metal comprises cobalt and/or iron.

11. A method as claimed in claim 1, wherein the surface area of the porous refractory oxide is from 10 m²/g to 200 m²/g.

12. A catalyst support or supported metal catalyst prepared according to claim 1 wherein the zirconium is in the form of zirconia.

13. A supported metal catalyst as claimed in claim 12 comprising between 0.1-25% w zirconia.

14. (canceled)

15. A catalyst body prepared according to claim 2, wherein the zirconium is in the form of zirconia.

16. A catalyst body as claimed in claim 15, wherein the catalyst on the metal comprises between 0.1-25% w zirconia.

17. (canceled)
